(19) United States
(12) Patent Application Publication
(10) Pub. No.: US 2010/0075589 A1
(43) Pub. Date: Mar. 25, 2010

(54) ANGLED BLOWER DECK APPARATUS AND METHOD

(76) Inventors: George Lee Joyner, JR., Florence, SC (US); John A. Toyne, Laurinburg, NC (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/233,774

(22) Filed: Sep. 19, 2008

(51) Int. Cl. F24F 7/06; B23P 17/00

(52) U.S. Cl. 454/338; 29/888

(57) ABSTRACT

A plenum air regulating system includes a housing and a blower deck assembly. The housing having at least one side-panel removably mounted on the housing and a door assembly mounted on one end of the housing. The door assembly is coupled with a wire guard and is capable for air circulation. The blower deck assembly is mounted inside the housing. The blower deck includes a blower deck mount, a blower housing, and heating elements. The blower housing is mounted on a first side of the blower deck mount. An internal motor is removably coupled within the blower housing. The blower deck mount is disposed at an angle inside the housing, such that the blower housing is at an angle relative to the bottom of the housing. The blower deck mount is tilted at an angle between 95 to 135 degrees. The blower deck mount is rotated at its midpoint by between 5 to 45 degrees. When air exits from an outlet of the blower housing, it is directed towards the middle of a second side of the blower deck assembly and over the heating elements.

### FIELD OF THE INVENTION

The present invention relates generally to air moving devices. More particularly, the present invention relates to blowers for drawing air from outside of a building. More particularly, the present invention relates to blowers for use in a building ventilation system.

### BACKGROUND OF THE INVENTION

Since the rise of industrialization, our society has been confronted with the problem of air pollution. In order to overcome this problem, buildings are equipped with air moving devices to maintain proper air flow indoors. Oftentimes, these air moving devices are also equipped with climate control features for providing a controlled temperature environment. These air moving devices are typically installed in concealed areas of a building that are not readily accessible by the building occupants. For example, these devices oftentimes positioned in the area between concrete ceiling and drop-tile ceiling. Due to the limited space between the concrete ceiling and the drop-tile ceiling, it is necessary to create an air moving device that can effectively provide proper air flow and at the same time, have a footprint that is compatible to the space.

Efforts have been made to over come the aforementioned problem by the introduction of plenum heaters to the industry. In order to be properly positioned with the ceiling, as previously discussed, the plenum heaters are equipped with a blower having an external motor that sits at the edge of the blower housing. This type of blower having an external motor configuration allows the system to be positioned within the ceiling. However, this configuration has drawbacks. Due to the wiring of the aforementioned blower motor configuration, the external motor cannot be serviced without the removal of the blower housing. Thus, excess time and effort must be spent to service the motor.

Accordingly, it is desirable to provide a blower apparatus and method that can be easily serviced while also being sized to be positioned between the concrete ceiling and the drop-tile ceiling, and other narrow places for example, without compromising the efficiency of air flow.

### SUMMARY OF THE INVENTION

The foregoing needs are met, to a great extent, by the present invention, wherein in one aspect an apparatus is provided that in some embodiments includes a plenum air regulating system that can be easily serviced upon and can fit between narrow areas.

In accordance with one embodiment of the present invention, a plenum air regulating system is provided, and includes a housing and a blower deck assembly. The housing includes at least one side-panel removably mounted on the housing and a door assembly mounted on one end of the housing. The door assembly is further coupled with a wire guard capable for air circulation. The blower deck assembly includes a blower deck mount and a blower housing. The blower deck mount having a first side and a second side. The blower housing is mounted on the first side of the blower deck. Furthermore, an internal motor is removably coupled within the blower housing, wherein the blower deck mount is disposed at an angle inside the housing. As a result, the blower housing is at an angle relative to the blower deck mount.

In accordance with another embodiment of the present invention, a plenum air regulating system is provided, including a housing and a blower deck assembly. The housing having at least one side-panel removably mounted on the housing and a door assembly mounted on one end of the housing. The door assembly is coupled with a wire guard capable for air circulation. The blower deck assembly mounted inside the housing, the improvement of the plenum air regulating system including a blower deck mount and a blower housing. The blower housing is mounted on a first side and an internal motor removably coupled within the blower housing. The blower deck mount is disposed at an angle inside the housing. As a result, the blower housing is at an angle relative to the blower deck mount.

In accordance with another embodiment of the present invention, a method of assembling a plenum air regulating system is provided, including (a) mounting a blower housing onto a blower deck mount to form a blower deck assembly; (b) placing the blower deck assembly inside a housing, wherein the blower deck assembly is placed at an angle inside the housing; (c) installing an internal motor inside the blower housing; (d) installing heating elements on a second side of the blower deck mount, wherein air exits the blower housing blows directly over the heating elements; (e) installing electrical components; and (f) placing a side panel onto the housing, wherein the side panel allows the internal motor to be serviced upon directly. The internal motor is mounted inside the blower housing prior to it mounting onto a blower deck mount. The blower housing is mounted with two door assemblies to provide intake and outlet of airflow.

In accordance with yet another embodiment of the present invention, a plenum air regulating system is provided, including a housing, a blower deck assembly and a heating element. The housing including four side-panels and two end panels. At least one of the four side-panel is removably mounted on the housing and a door assembly is mounted on one of the two ends of the housing. The door assembly is coupled with a wire guard that is capable for air circulation. The blower deck assembly mounted inside the housing, including a blower deck mount and a blower housing. The blower deck mount having a first side and a second side. The blower housing mounted on the first side of the blower deck mount and an internal motor removably coupled within the blower housing. The blower deck mount is disposed at an angle inside the housing. As a result, the blower housing is at an angle relative to the blower deck mount. The blower housing further consists of an outlet. Air exiting from the outlet is directed towards the middle of the second side of the blower deck assembly. The heating elements are situated on the second side of the blower deck. Thus, when air exits from the outlet of the blower housing it is directed over the heating element.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings.

The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a plenum heater equipped with a blower having an external motor.

FIG. 2 is a perspective view illustrating a plenum heater according to a preferred embodiment of the invention.

FIG. 3 is a schematic diagram of a plenum heater according to a preferred embodiment of the invention.

FIG. 4A is a schematic diagram of the plenum heater regulating system equipped with an internal motor.

FIG. 4B is a schematic diagram of a plenum heater equipped with an internal motor.

FIG. 4C is a schematic diagram of a plenum heater according to a preferred embodiment of the invention.

### DETAILED DESCRIPTION

The invention will now be described with reference to the drawing figures, in which like reference numerals refer to like parts throughout. An embodiment in accordance with the present invention provides a plenum air regulating system that can be easily serviced and that can be placed within narrow areas.

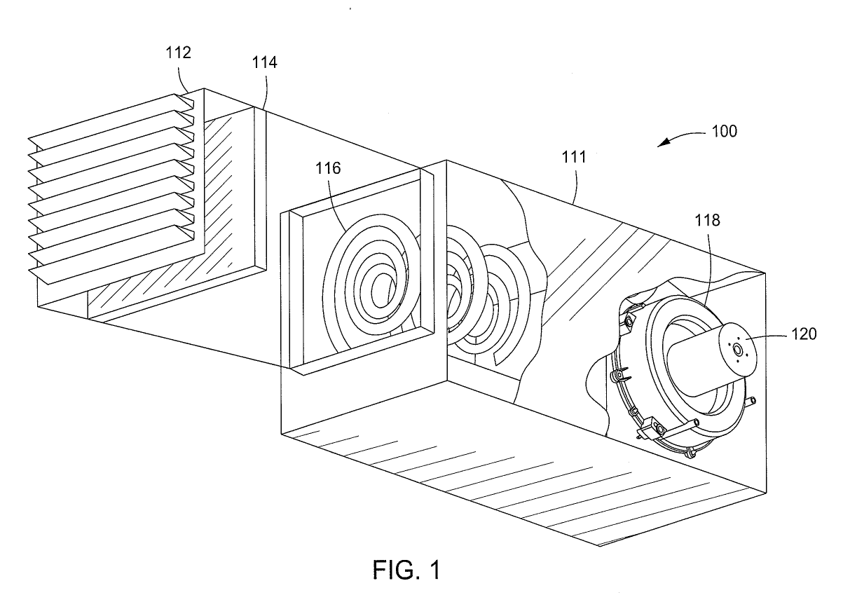

FIG. 1 is a perspective view illustrating a plenum heater equipped with a blower having an external motor. In order to fit within a narrow area, such as ceilings, the plenum heater (100) are equipped with a blower (118) having an external motor (120) that sits at the edge of the blower housing. This type of blower motor configuration allows the system to fit between the ceilings, for example, the plenum heater as depicted in FIG. 1. The plenum heater (100) has a blower housing (111), a wire guard (112), a filter (114), a set of coil heating element (116), a blower housing (118) and an external blower (120). However, due to the wiring of this external blower motor configuration, the external motor (120) cannot be serviced upon without the removal of the blower housing (118). Therefore, the service person must remove the blower housing (118) before working on the external motor (120). Accordingly, excess time and effort must be spent to remove the system before serving the motor.

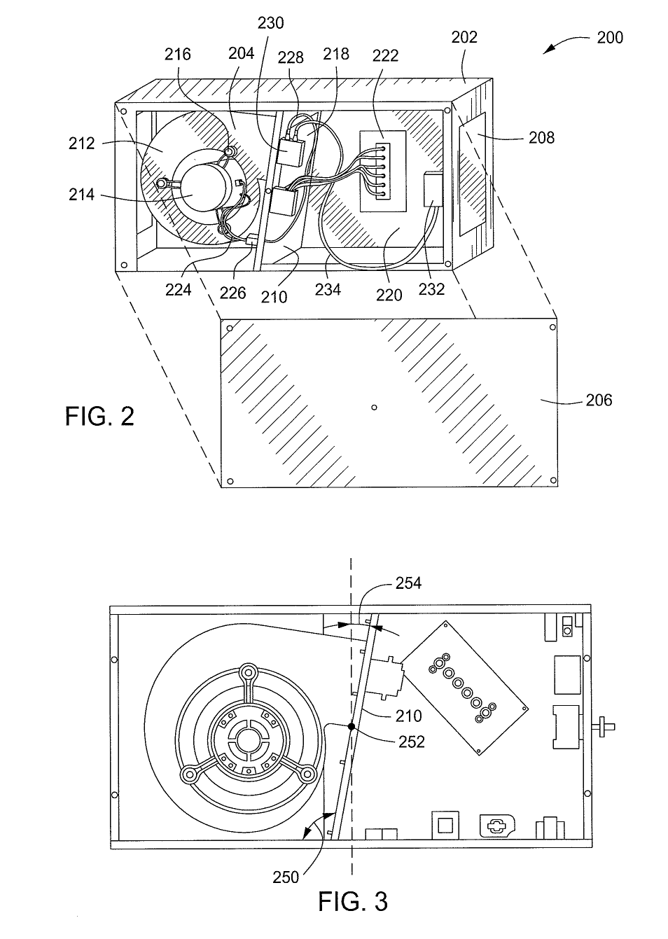

An embodiment of the present disclosed angled blower deck apparatus is illustrated in FIG. 2. A plenum air regulating system (200) having a housing (202) and a blower deck assembly (204). The housing (202) has a removable side panel (206) and a door assembly (208) on at least one end of the housing. This door assembly can be coupled with a wire guard (not shown) for air circulation.

The blower deck assembly (204) is mounted on the inside of the housing. The blower deck assembly (204) has a blower deck mount (210) and a blower housing (212) with an internal motor (214). The internal motor is secured to the blower housing (212) via screws (216) or other similar fasteners. This type of blower housing (212) with internal motor (214) is generally known as a centrifugal blower or an squirrel cage blower. Other types of blower assemblies with an internal motor may be used with the present disclosed apparatus.

As depicted in FIG. 3, the blower deck mount (210) is placed at an angle inside the housing. The blower deck mount (210) is positioned at an obtuse angle (250) with respect to the bottom of the housing. The blower housing (212) is also disposed at an angle (254) relative to the blower deck mount (210). The blower deck mount (210) has a passage (218). The outlet of the blower housing (212) is connected to the passage (218) such that air generated from the blower housing (212) via the internal motor (214) exits the passage (218). The blower deck mount (210) is tilted in such a way that air exiting the passage (218) is directed towards the middle of a second side (220) of the blower deck assembly (204). According to an embodiment of this invention, air exiting from the passage (218) is blown at an angle downward and to the middle of the second side (220) of the blower housing (212).

Returning to FIG. 2, the blower housing (212) has at least one set of heating elements (222) coupled to the second side (220) of the blower deck assembly (204). When the heating element (222) is activated, air exiting from the blower housing (212) through the passage (218) blows directly over the heating element (222) and is heated before exiting the door assembly (208) of the housing (202). By tilting the blower housing (212) and the blower deck mount (210) at an obtuse angle, air exiting the blower housing (212) is blown directly over the heating element. This configuration avoids the likelihood of any unnecessary heat spots or cold spots in the unit and the plenum air regulating system is more likely to maintain a temperature of less than 200° C.

As previously mentioned, the heating element (222) is placed on the second side (220) of the blower deck assembly (204). A clearance around the heating element is necessary to maintain the temperature of the plenum air regulating system (200) and to prevent the plenum air regulating system (200) from getting over heated. The clearance is also necessary so that while the plenum air regulating system (200) is emitting heated air at the door assembly (208), the outside of the plenum air regulating system (200) is cool.

Continuing with FIG. 2, the housing (202) of the plenum air regulating system (200) has door assemblies (208) on two opposing sides. Both of the door assemblies (200) are mounted with a wire guard (not shown) to direct air flow. In addition, a filter can be added to the blower housing side (212) of the plenum air regulating system (200) to prevent large particles or dust from entering the assembly (200). Furthermore, the housing (202) has a removable side panel (206). This removable side panel (206) is mounted on the housing (202) preferably via five screws, one at each corner of the removable side panel (206) and one in the middle, connecting the removable side panel (206) to the blower deck mount (10). The screws can be substituted by any type of fastener. Therefore, a service person would only need to remove the five screws to service the plenum air regulating system (200). Thus, access to the internal components is simplified by the removal of the screws on a single front panel. Alternatively, the removable side panel (206) can be two separate panels, one covering the blower housing side (212) and another one covering the heating element side (220). Thus, the motor can be serviced by removing one panel.

In accordance with an embodiment of the present disclosure, the plenum air regulating system (200) is equipped with modularized parts, which allows for the various parts to be removed or serviced without disruption to other parts of the plenum air regulating system (200). As discussed above, a squirrel cage (or centrifugal) type blower housing (212) with internal motor (214) is a type of blower used according to the present disclosure. The internal motor (214) is nested inside the blower housing (212) and is mounted via three screws (216). As illustrated in FIG. 2, electric conductive wires (224) used internal motor (214) have a male/female pin connector (226), which allows the internal motor (214) to be easily removed from the blower housing (212) and disconnect from the power source. Thus, the internal motor (214) can be serviced without taking apart other portion of the plenum air regulating system (200).

A second electric conductive wire (228) is connected the male/female pin connector (226) which extends to a low voltage controller (230). A third wire (234) then connects the low voltage controller (230) to a disconnect switch (232). The disconnect switch (232) allows the service person to disconnect power to the plenum air regulating system (200) before servicing the unit. This modularized approach to the wiring accommodates the ease of assembling and disassembling various components.

As discussed above, the plenum air regulating system 200 has a removable side panel (206). This removable side panel (206) is on the side where the internal motor (214) is fastened to the blower housing (212). By removing this side panel (206), the internal motor (214) can be removed from the blower housing (212) along with the wires (224). This preferred set up allows for the internal motor (214) to be serviced without the removal of other elements in the plenum air regulating system.

FIG. 3 is a schematic diagram of a plenum heater according to a preferred embodiment of the invention. According to an embodiment of this invention, the blower deck mount (210) can be tilted at an obtuse angle (250) relative to the bottom of the housing, i.e. not perpendicular, inside the housing (212). In accordance to an embodiment of this invention, the blower deck mount (210) can be tilted at a 135 degree angle relative to the bottom of the housing. Yet, in accordance with another embodiment of this invention, the blower deck mount is tilted at an angle between 95 and 135 degrees relative to the bottom of the housing. The blower deck mount (210) can also be tiled at an angle between 100 and 120 degrees relative to the bottom of the housing.

Alternatively, according to an embodiment of this invention, the blower deck mount (210) can be rotated at its midpoint (252) by between 5 to 45 degrees (254). According to yet another embodiment of this invention, the blower deck mount (210) can be rotated at its midpoint (252) by 10 to 30 degrees.

Because the blower housing (212) is mounted on the blower deck mount (210), the blower housing (212) is also tilted at an angle relative to the blower deck mount (210). In accordance with an alternative embodiment of the present invention, the blower housing (212) is mounted on a blower deck mount (210) that has a half moon shape or curved shape. Other configuration can be used where the configuration accommodates the maintenance of a certain temperature, such as 200° C. around the heating element. Thus, the blower housing (212) can still be mounted such that air exiting the housing is blown toward the center of the second side (220) of the blower deck. The placement and degree of tilting of the blower housing (212) is determined by the location of the heating element (222) to maximize the airflow and decrease turbulence.

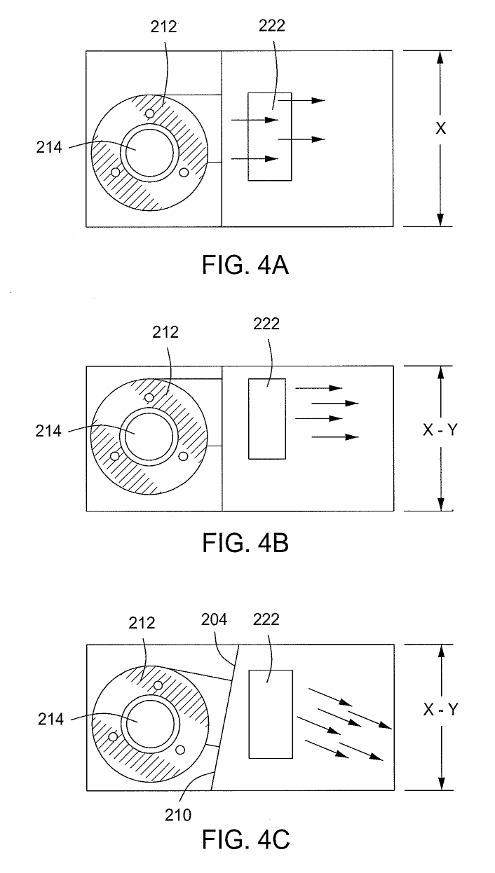

FIG. 4A is a schematic diagram of the plenum heater regulating system equipped with an internal motor (214). In order to keep the air flow centered, the blower housing is centered in the housing. As illustrated, this plenum heater has a height of X and air flows over the heating element. This set up is undesirable because the plenum heater needs to be placed in restricted space.

FIG. 4B is another schematic diagram of a plenum heater equipped with an internal motor (214). As shown in FIG. 4B, the height of the plenum air regulating system is less than that illustrated in 4A, with a height of X-Y to allow the plenum air regulating system to fit in narrow places. As shown in FIG. 4B, the plenum does not distribute air flow evenly. As a result, some area of the plenum air regulating system is too hot, i.e. the top of the plenum air regulating system, and some area is too cold, i.e., the bottom of the plenum air regulating system. Therefore, this set up is also undesirable.

FIG. 4C is a schematic diagram of a plenum heater according to an embodiment of the present invention. The blower deck assembly (204) along with the blower deck mount (210) and the blower housing (212) are tilted allowing for clearance around the heating element (222), where the air exiting the blower housing blows directly over and across the heating element (222). This set up creates even air flow across the heating element (222) and eliminates the hot and cold spots issues with the plenum heater of FIG. 4B. This set up also allows the plenum air regulating system to have a height of X-Y to fit between narrow places.

In accordance with an embodiment of the present invention, the plenum air regulating system can be assembled by first preparing the housing (202). Then, the blower deck assembly (204) added by affixing the blower housing (212) onto the blower deck mount (210). Next, the blower deck assembly (204) is mounted in the housing (202). The internal motor (214) is then attached to the blower housing (212) using screws. The heating element (222) is then placed in the housing (202). Then, the electrical components, i.e. controller (230), are placed in the housing and wires (224, 228, and 234) are attached in their respectively places. The removable side panel (206) and the door assemblies (208) are attached to the housing next. Optionally, a filter can be placed behind the door assemblies of the blower housing side to eliminate particles or dust from entering into the blower housing.

Alternatively, the internal motor (214) can be placed inside the blower housing (202) prior to the blower housing (202) mounting to the blower deck mount (210). Also, alternatively, the heating element (222) can be placed inside the housing (202) prior to the installing of the blower deck mount (210).

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A plenum air regulating system, comprising:
(a) a housing having at least one side-panel removably mounted on the housing and a door assembly mounted on one end of the housing, wherein the door assembly is coupled with a wire guard capable for air circulation; and
(b) a blower deck assembly mounted inside the housing, the blower deck comprises:
a blower deck mount having a blower housing mounted on a first side and an internal motor removably coupled within the blower housing, wherein the blower deck mount is disposed at an obtuse angle inside the housing with respect to the bottom of the housing, such that the blower housing is at an obtuse angle relative to the bottom of the housing.

2. The assembly of claim 1, wherein the blower deck mount is tilted at an angle between 95 to 135 degrees.

3. The assembly of claim 1, wherein the blower deck mount is tilted at an angle between 100 and 115 degrees.

4. The assembly of claim 1, wherein the blower deck mount is rotated at its midpoint by between 5 to 45 degrees.

5. The assembly of claim 1, wherein the blower deck mount is rotated at its midpoint by 10 to 25 degrees.

6. The assembly of claim 1, wherein air exiting from an outlet of the blower housing is directed towards the middle of a second side of the blower deck assembly.

7. The assembly of claim 6, further comprising a heating element coupled to the second side of the blower deck, thereby air exiting from the outlet of the blower housing is directed over the heating element.

8. The assembly of claim 1, wherein the internal motor is accessible and is serviceable by removing the side-panel.

9. The assembly of claim 7, wherein the blower housing has a clearance around the heating element such that the blower housing is below 200° C.

10. A plenum air regulating system, comprising:
a housing having at least one side-panel removably mounted on the housing and a door assembly mounted on one end of the housing, wherein the door assembly is coupled with a wire guard capable for air circulation; and
a blower deck assembly mounted inside the housing, comprises:
a blower deck mount having a blower housing mounted on a first side and an internal motor removably coupled within the blower housing, wherein the blower housing is mounted at an obtuse angle relative to the bottom of the housing,
a heating element coupled to a second side of the blower deck assembly, wherein the blower housing has a clearance around the heating element such that the blower housing is below 200° C.

11. The assembly of claim 10, wherein the blower housing is tilted at an angle between 95 to 135 degrees.

12. The assembly of claim 10, wherein the blower housing is tilted at an angle between 100 and 115 degrees.

13. The assembly of claim 10, wherein the blower housing is rotated at its midpoint by between 5 to 45 degrees.

14. The assembly of claim 10, wherein the blower housing is rotated at its midpoint by between 10 and 25 degrees.

15. The assembly of claim 10, wherein air exiting from an outlet of the blower housing is directed towards the middle of the second side of the blower deck assembly.

16. The assembly of claim 10, whereby air exiting from the outlet of the blower housing is directed over the heating element.

17. A plenum air regulating system, comprising:
(a) a housing having four side-panels and two end panels, wherein at least one of the four side-panel is removably mounted on the housing, and a door assembly mounted on one of the two ends of the housing, wherein the door assembly is coupled with a wire guard capable for air circulation;
(b) a blower deck assembly mounted inside the housing, the blower deck comprises:
a blower deck mount having a first side and a second side,
a blower housing mounted on the first side of the blower deck mount and an internal motor removably coupled within the blower housing, wherein the blower deck mount is disposed at an obtuse angle inside the housing and relative to the bottom of the housing, such that the blower housing is at an angle relative to the blower deck mount, wherein the blower housing consist of an outlet, wherein air exiting from the outlet is directed towards the middle of the second side of the blower deck assembly; and
(c) heating elements situated on the second side of the blower deck, thereby air exiting from the outlet of the blower housing is directed over the heating element.

18. A method of assembling a plenum air regulating system, comprising:
(a) mounting a blower housing onto a blower deck mount to form a blower deck assembly;
(b) placing the blower deck assembly inside a housing, wherein the blower deck assembly is placed at an angle inside the housing;
(c) installing an internal motor inside the blower housing;
(d) installing heating elements on a second side of the blower deck mount, wherein air exits the blower housing blows directly over the heating elements;
(e) installing electrical components; and
(f) placing a side panel onto the housing, wherein the side panel allows the internal motor to be serviced upon directly.

19. The method of claim 18, wherein the internal motor is mounted inside the blower housing prior to it mounting onto a blower deck mount.

20. The method of claim 18, wherein the blower housing is mounted with two door assemblies to provide intake and outlet of airflow.
